(19) United States
(12) Patent Application Publication
(10) Pub. No.: US 2014/0172588 A1
(43) Pub. Date: Jun. 19, 2014

(54) Method and Apparatus for Embedded Graphical Advertising

(71) Applicants: Scott Frankel, Los Angeles, CA (US); Greg Lam, Los Angeles, CA (US)

(72) Inventors: Scott Frankel, Los Angeles, CA (US); Greg Lam, Los Angeles, CA (US)

(21) Appl. No.: 13/719,743

(22) Filed: Dec. 19, 2012

(51) Int. Cl. G06Q 30/02

(52) U.S. Cl. CPC G06Q 30/0276
USPC 705/14.72

(57) ABSTRACT

A system includes a processor configured to receive input of a photograph to which an advertisement will be applied and receive selection of an item within the photograph. The processor is further configured to present a plurality of input fields relating to characteristics of the item and receive input in one or more of the fields. Also, the processor is configured to receive at least one database record corresponding to received input. The processor is additionally configured to present the at least one database record to a content creator for selection. The processor is also configured to receive selection of at least one database record and store the selected at least one database record with respect to the photograph, including at least identification of a content provider where the photograph will be displayed.

### TECHNICAL FIELD

The illustrative embodiments generally relate to a method and apparatus for embedded graphical advertising.

### BACKGROUND AND SUMMARY OF ILLUSTRATIVE EMBODIMENTS

Product placement has played a key role in advertising for decades. For example, in many movies, advertisers will pay a studio, producer or director to place an object in a movie with a label displayed prominently. Viewers watching the movie will have their attention intentionally or incidentally drawn to the products, and the advertisers will thereby receive attention for their products.

Consumers wishing to purchase the products shown in the movies, however, must go out to the store or online on the Internet to find the products. Certain products may be labeled and easy to find, such as, for example, a can of COCA-COLA. Because the product can be easily referenced and found by the consumer, the advertiser will likely be willing to pay a fair amount of money for the product to be shown in the movie.

On the other hand, there are hundreds of items shown in movies that do not have labels visually associated with them. Because it may be difficult or even impossible for the average consumer to find out who made these products, or how to purchase them, the designers/advertisers may not be willing to pay much or anything for placement of these products in a movie.

Similarly, product placement can be done in advertising in mediums such as newspapers and magazines. In one illustrative example, a photograph in a newspaper or magazine may be designed to show a particular product. In such a display, the product is the focus of the image and is displayed prominently. Typically there is additionally some information associated with the product, such as where or how to buy the product.

In another example, a photograph of, for example, a model wearing a particular outfit may be shown. Each item in the outfit may be for sale. In some magazines, there is a listing of the various items in the outfit, and/or costs, and/or places where the items may be purchased (such as websites).

In both of the preceding examples, advertisers are usually willing to pay for the display of the images in a magazine or newspaper because, like in the movies, people viewing the photograph can determine what products are being advertised and where to purchase those products.

In yet a further example, a photograph of, for example, a celebrity may be shown. The photograph may be displayed in conjunction with a feature on that celebrity or on celebrities in general (such as a red carpet event). Or the photograph could even be one taken by, for example, paparazzi.

Typically, in these photographs, the products worn by the celebrity and/or in the background are not the focus of the photograph and many times are unidentified. Or, even if they are identified, the identification may simply be the identification of a designer, and not include the specific item or where it can be purchased.

Finally, many magazines, television shows, and newspapers are becoming increasingly available online. In the preceding examples, if an item is identified in some text associated with a photograph, a hyperlink to the item may also be provided. In a medium such as this, advertisers can get a better measure of the effectiveness of advertisements because clicks through the hyperlinks can be tracked. This allows advertisers to determine an appropriate price to pay for an advertisement based on the volume of traffic the advertisement generates.

In a first illustrative embodiment, an online image or movie is used to provide product advertising. The image or movie can be any type of image or movie, and does not need to be specifically tailored for the advertisement of a particular product. For example, a picture of a celebrity at an event may be shown.

In this example, each or some of the items the celebrity is wearing (shoes, sunglasses, dress, handbag, etc.) may be hyperlinked in the picture itself. That is, instead of providing a text-based description of one or more products, a user may be able to mouse over the specific item he or she is interested in and be directly linked to the product by clicking. That is to say, it is not the entire picture itself that is linked, but one or more of numerous purchasable items within the picture are linked to individual sites where that item can be purchased. This can allow almost any photograph to be turned into an advertisement, as well as allowing the photograph to convey whatever original meaning was intended.

Since no extra text is necessary to provide access to the products, there is no distraction from the original intent of the photograph. For example, an article in an architectural magazine may show the design of a room in connection with an article about the building in which the room exists. It may not be common for such an article to include the particulars of the items shown in the photograph, since the article is about the building. But, with the exemplary illustrative embodiments, any photograph, including one such as mentioned above, can be turned into a dynamic advertisement, linking the items contained therein to the sites where they can be purchased. Such linking can be done via individual hyperlinks for each item, even though the photograph may not be a photograph typically used for advertising an item. An editorial picture in an article can thus be dynamically transformed into an advertisement providing a plurality of purchasable goods.

In a further illustrative embodiment, moving images, such as a television show or a movie can also potentially contain dynamic advertisements. Since the images can be moused over while being viewed online, hyperlinked advertising can be accessed.

In one illustrative embodiment, a method of electronic advertising includes displaying an image showing a plurality of purchasable goods. The method further includes providing selectable portions of the image, wherein a plurality of the selectable portions are each substantially defined by the perimeter of one of the purchasable goods.

The method also includes detecting a selection of a selectable portion and displaying a browser window. The browser window (which may include a window already being displayed) includes at least a portion of the window provided by a seller of a given purchasable good in response to selection of the selectable portion corresponding to the given selectable good. Finally, the method includes tracking selections of selectable portions, wherein at least two of the purchasable goods are provided by different sellers. In this embodiment the tracking is tracked separately for each of the sellers.

In a second illustrative embodiment, a method of electronic advertising includes determining a plurality of portions of an image that are to be designated as mouse-clickable portions. In this embodiment, each of the mouse-clickable portions corresponds to a single item to be offered for sale. At least two of the items are provided by different sellers in this illustrative embodiment.

Finally in this illustrative embodiment, the method includes designating each of the plurality of portions as mouse-clickable portions and providing a hyper-link in conjunction with each of the mouse-clickable portions. When a given mouse-clickable portion is clicked on by a user, the hyper-link causes a web browser to display a site offering the item shown in the mouse-clickable portion for sale.

In still a third illustrative embodiment, a computer readable storage medium, stores one or more instructions executable by a computer reading the computer readable storage medium.

In this illustrative embodiment, the instructions cause the computer to display an image having a plurality of designated mouse-clickable portions, wherein at least two of the mouse-clickable portions correspond to purchasable goods provided by different sellers.

The computer is also caused to detect a mouse click on one of the mouse-clickable portions. The computer is further caused to, in response to the mouse click, display a website offering for sale an item displayed in the mouse-clickable portion.

In another illustrative embodiment, a system includes a processor configured to receive input of a photograph to which an advertisement will be applied and receive selection of an item within the photograph. The processor is further configured to present a plurality of input fields relating to characteristics of the item and receive input in one or more of the fields. Also, the processor is configured to receive at least one database record corresponding to received input. The processor is additionally configured to present the at least one database record to a content creator for selection. The processor is also configured to receive selection of at least one database record and store the selected at least one database record with respect to the photograph, including at least identification of a content provider where the photograph will be displayed.

In yet another embodiment, a computer implemented method includes receiving input of a photograph to which an advertisement will be applied. The method also includes receiving selection of an item within the photograph. The method further includes presenting, from a data processing computer, a plurality of input fields relating to characteristics of the item. The method additionally includes receiving input in one or more of the fields. The method also includes receiving at least one database record corresponding to received input and presenting the at least one database record to a content creator for selection. Also, the method includes receiving selection of at least one database record and storing the selected at least one database record with respect to the photograph, including at least identification of a content provider where the photograph will be displayed.

In another illustrative embodiment, a computer readable storage medium stores instructions that, when executed by a processor, cause the processor to perform a method including receiving input of a photograph to which an advertisement will be applied. The method also includes receiving selection of an item within the photograph. The method further includes presenting, from a data processing computer, a plurality of input fields relating to characteristics of the item. The method additionally includes receiving input in one or more of the fields. The method also includes receiving at least one database record corresponding to received input and presenting the at least one database record to a content creator for selection. Also, the method includes receiving selection of at least one database record and storing the selected at least one database record with respect to the photograph, including at least identification of a content provider where the photograph will be displayed.

### BRIEF DESCRIPTION OF THE DRAWINGS

FIG. 1a shows an illustrative example of a photograph includable with an online article;

FIG. 1b shows a view of the photograph shown in FIG. 1a, with exemplary hyperlinked portions displayed;

FIG. 1c shows a view of the photograph shown in FIG. 1b, with an exemplary pop-up display shown;

FIG. 2 shows an illustrative example of a process for displaying an image having differing selectable portions;

FIG. 3 shows an illustrative example of a second process for displaying an image in accordance with FIG. 2, including a process for displaying a tool-tip;

FIG. 4 shows an illustrative example of a process for preparing an image for multiple item selectability and purchasability;

FIG. 5 shows an illustrative example of a visual layout for advertisement creation;

FIG. 6 shows an illustrative example of an illustrative process for advertisement creation;

FIG. 7 shows an illustrative example of an item discovery process;

FIG. 8 shows an illustrative example of a retailer presentation process;

FIG. 9 shows an illustrative example of a photo tagging process;

FIG. 10 shows an illustrative example of a presentation tracking process;

FIG. 11 shows an illustrative example of a mobile presentation process;

FIG. 12 shows an illustrative example of a video presentation process;

FIG. 13 shows an illustrative example of a statistic presentation process;

FIG. 14 shows an illustrative example of purchase tracking and handling; and

FIG. 15 shows an example of a purchase analytics function.

### DETAILED DESCRIPTION

Detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

Although described as methods in the illustrative examples presented herein, each of the methods can also be automatically performed by, for example, a computer reading a computer readable storage medium storing instructions (such as, but not limited to, a hard disk drive, a CD, a DVD, a flash drive, etc.). The computer receiving the instructions can execute them to perform the various illustrative embodiments.

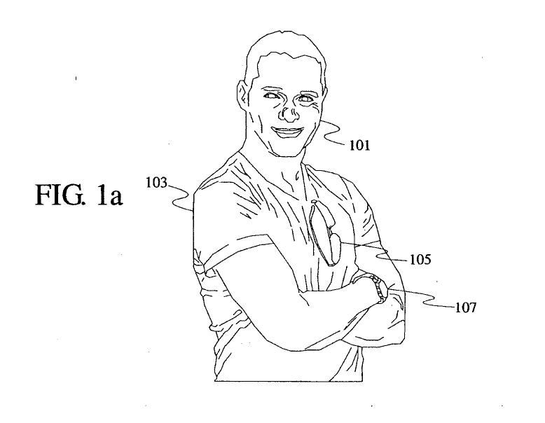

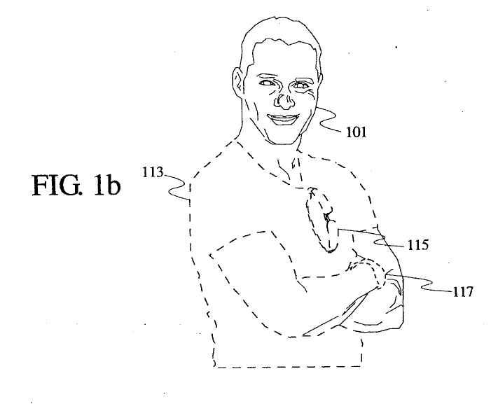

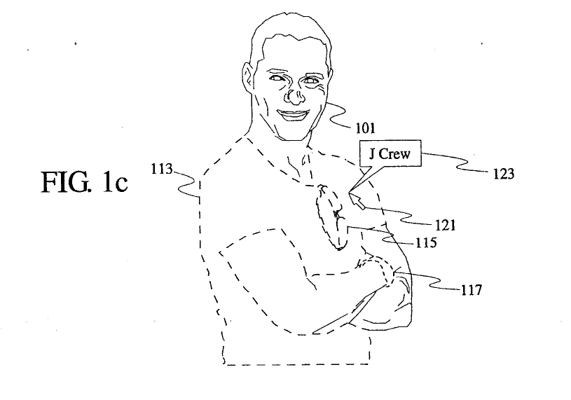

FIG. 1a shows an illustrative example of a digital photograph includable with an online article. The photograph is shown in wire frame form for the sake of this application, but it is intended that the illustrative embodiments are applicable to actual photographs, whether those photographs were shot for advertising purposes or otherwise, as well as generated images and/or video/movie footage (including electronically generated movies).

In this illustrative embodiment, a photograph has been taken of a celebrity 101 for inclusion with an online article to be published on a website. While applicable to photographs taken for advertisement purposes, this illustrative example is directed at a photograph taken for purposes of the article, but not necessarily originally intended for advertisement purposes.

In this photograph shown in FIG. 1, the celebrity 101 is wearing three items that are possible to buy. He is wearing a t-shirt 103, a pair of sunglasses 105, and a watch 107. Although the picture was not taken to advertise these items, it is within the consideration of the illustrative embodiments that these items could be offered easily for sale.

Since there are numerous such photographs provided in online articles and the like, each item in each photograph could potentially provide advertisement revenue. This can be an entirely new source of revenue for producers of online magazines, newspapers, blogs, etc. Further, since each of the items is likely made by a different seller (or designer, etc.), each photograph can provide advertisement revenue from a plurality of sources.

Selections of the various items in the photographs can be tracked in order to inform advertisers and/or set a base for the cost of the advertisements.

FIG. 1b shows a view of the photograph shown in FIG. 1a, with exemplary hyperlinked portions displayed. In this illustrative embodiment, each of the three items, the t-shirt, the sunglasses and the watch is available for purchase.

Although the perimeter definitions (shown by dashed lines in FIG. 1b) of the objects may not be seen by the user, they can be defined to outline the various items that are purchasable in a given image. For example, in this image, the t-shirt has a clickable area defined by the perimeter 113. The sunglasses have a clickable area that is defined by the perimeter 115, and the watch has a clickable area that is defined by the perimeter 117.

In this illustrative embodiment, clickable areas are defined by perimeters that look like the objects that they are associated with. Since this could possibly present a great deal of work to do manually, defining these perimeters may be done by an automated program. Alternatively, the objects may simply be surrounded by a simply shaped perimeter (square, circle, or even a simple general polygon or smooth shape) that more basically defines the object as selectable. For example, in the picture shown, a large rectangle could define the t-shirt, and smaller rectangles could define the watch and sunglasses. Any suitable means of designating the various objects is acceptable.

Although the clickable areas may not be shown, a visual cue may be provided to the user to indicate that one or more areas of an image are clickable. This could be, for example, an icon on the picture used to designate interactability, a set of instructions, an outline of the clickable portions, etc.

FIG. 1c shows a view of the photograph shown in FIG. 1b, with an exemplary pop-up display shown. In this illustrative embodiment, it is desired to provide additional information to a user regarding one or more of the various items offered for sale in the photograph.

In this illustrative embodiment, a mouse cursor 121 can be positioned over the various clickable portions (113, 115, 117) in the photograph. Positioning of the cursor over a clickable portion causes a pop-up window 123 to appear.

In the shown illustrative embodiment, the pop-up window includes a designer of the t-shirt over which the cursor is positioned. In other illustrative embodiments, additional information may be included.

Using the pop-up information, users can obtain information about a product before clicking on it, providing a more informational browsing/shopping experience.

Although a celebrity wearing clothing has been shown for illustrative purposes, the illustrative embodiments are not limited to clothing. Purchasable goods under the illustrative embodiments can include, but are not limited to fashion items, beauty items, home furnishing, electronics, automobiles, travel packages, restaurants and restaurant reservations, household items, electronics, books, movies, etc. It is the intent of the inventors that the illustrative embodiments be usable for advertising any item that may appear in an electronic image, to the extent that there is a market for that item.

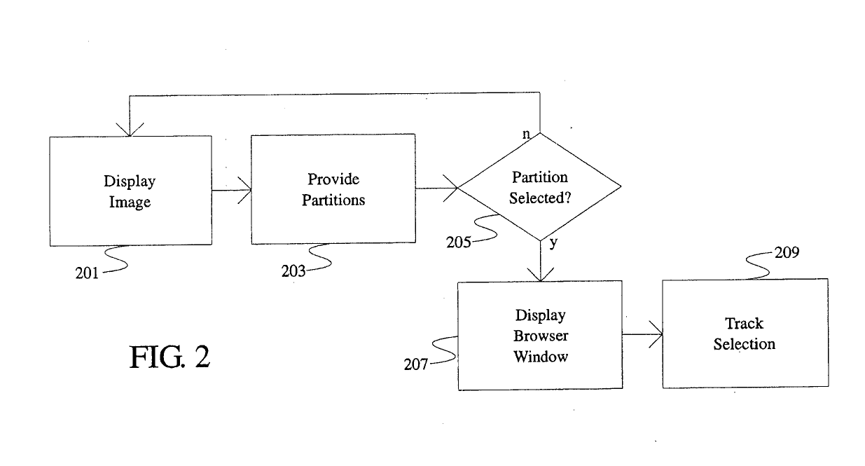

FIG. 2 shows an illustrative example of a process for displaying an image having differing selectable portions. In this illustrative non-limiting embodiment, an image is first displayed 201. The image can be a photograph, an advertisement, a computer generated image, etc. A video could also be displayed, or a computer generated movie, such as a FLASH movie.

Partitions are also provided 203. In this illustrative embodiment, the partitions define various portions of the image corresponding to purchasable goods. For example, the partitions could define the t-shirt, watch and sunglasses shown in FIG. 1a.

The partitions may be defined by the perimeters of the purchasable objects, or they may be polygons or smooth shapes more generally surrounding an image.

In this illustrative embodiment, it is then determined whether a selectable portion has been selected 205. If a partition has not been selected, the image and the partitions continue to be displayed (the partitions themselves may not be visible to a user).

If a partition has been selected, a website or browser window is then displayed 207 including, but not limited to, for example, a sub-display (such as a frame) within a browser window presently being viewed, a separate browser window, a separate tab (such as provided by INTERNET EXPLORER), etc. In some manner, display of a window is provided such that at least a portion of the window corresponds to the purchasable good and is provided by a seller of the purchasable good.

Finally, in this illustrative embodiment, the selection is also tracked 209. The selection can be tracked, for example, by seller (e.g., without limitation, if the seller makes more than one good displayed in the image) or it can be on a product by product basis. Tracking aids in determining the effectiveness of the advertising and allows, for example, the vendor providing the medium through which the advertising is performed to set pricing appropriately.

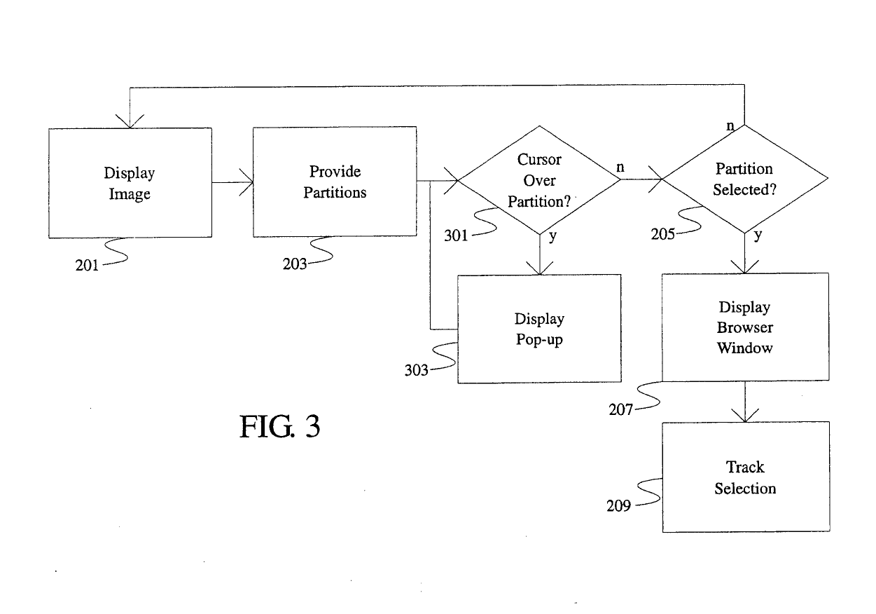

FIG. 3 shows an illustrative example of a second process for displaying an image in accordance with FIG. 2, including a process for displaying a tool-tip. In this illustrative embodiment, extra determinations are provided once partitioned portions of an image have been provided.

Here, after the partitions are provided 203, a determination is made as to whether or not a cursor is over a partition 301. The cursor may be required to rest in a stationary position over a partition for a period of time, to pass over the partition in any manner, or to remain within a partition (while moving for example) for a period of time.

If the determination is made that a pop-up is appropriate, then a pop-up is displayed in any suitable fashion 303.

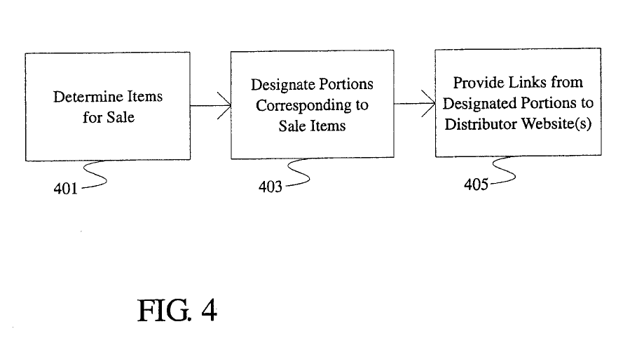

FIG. 4 shows an illustrative example of a process for preparing an image for multiple item selectability and purchasability. In this illustrative embodiment, an image is examined and it is determined which items in the image are purchasable and/or desired to be made purchasable through display of the image 401.

Portions of the image are then designated as selectable portions 403. These portions correspond to the purchasable goods. As previously noted, such designations can correspond to the perimeters of the items, they can be polygons or smooth shapes surrounding an object or including substantial portions of the object.

Finally, in this illustrative embodiment, links are provided to the portions corresponding to the purchasable goods 405. These links can cause new windows to open when clicked, cause a change in the state of the present window, cause a new tab to open, etc.

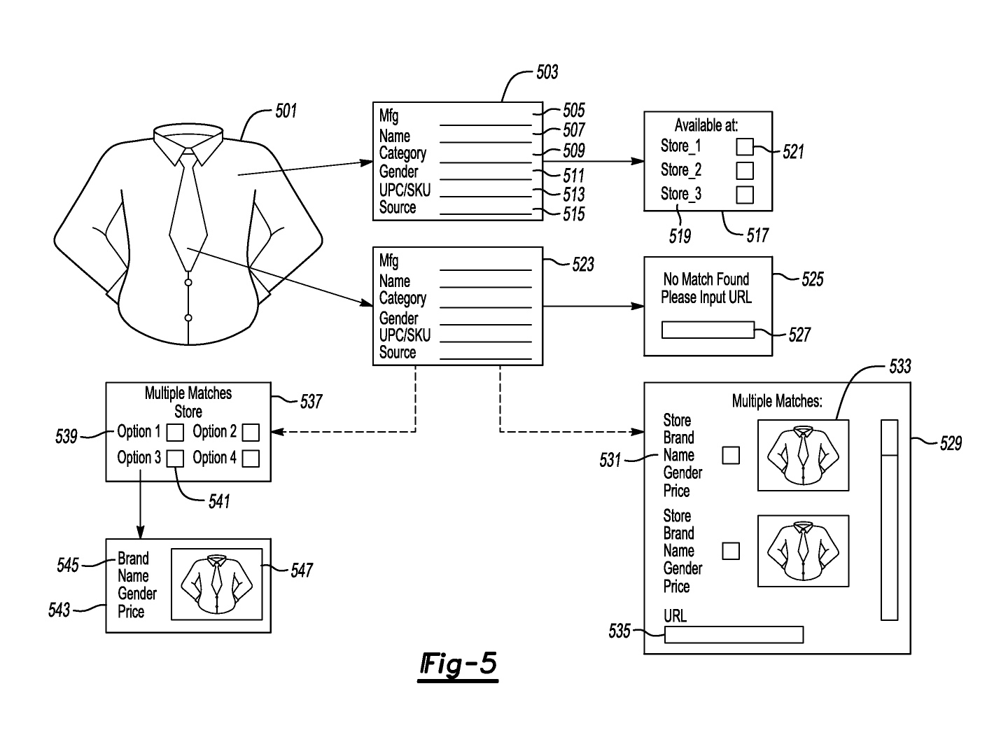

FIG. 5 shows an illustrative example of a visual layout for advertisement creation. In this illustrative example, a content provider has accessed an intermediary application for the purpose of utilizing the application to create an advertisement out of a photograph in an online publication. In one example, the application runs as a plug in on the content provider's back end site, allowing quick access while content is being created.

In this example, the process is shown with respect to a shirt, which is an exact or similar match to a shirt being worn by someone in a picture on the website. By running the content creation tool, the advertiser can click on some portion of the shirt shown in the picture 501 (which is the picture shown on the site).

When the application is running on the content creation site, the click on the shirt (after initializing the application, for example) may launch a secondary window 503, 523. Two windows are shown in this example, because entry of varied data in the windows may lead to different tertiary windows.

In window 503, the content provider is given a number of data entry options in which the creator can attempt to match the product shown in the picture to a product in a database maintained, for example, by an intermediary party between content creators and retailers. In this example, the a number of illustrative categories are available in the secondary window, which can be used to enter data to find a match or near-match for the product shown.

A manufacturer category 505 (e.g., DKNY), a product name 507 (e.g., gingham shirt), a category 509 (e.g., shirt), a gender 511 (e.g., male), and a UPC/SKU 513 (inputtable if known) can be used to identify the product. The last category, source 515, can be used to identify the content creator so that money provided by a retailer when a product is bought can be routed to an appropriate source. In this case, the name of the online publication could be input and cross referenced with a database of participating sources. Alternatively, because each publisher may have a unique account with login credentials to create these sales opportunities, this step can be automatically be completed and associated to the account in use for proper attribution of data and fees generated.

Assuming that the product entry into the lookup window 503 results in a match, the process may then provide a tertiary window 517 which lists one or more retailers which sell that exact product. In this example, the intermediary application and database provider has a database of participating retailers, which lists inventory levels, products, pricing and other useful information. By entering sufficient data in the secondary window, matches from this database can be presented in the tertiary window to provide precise links to products sold by participating retailers (i.e., retailers who are willing to pay for advertising and site-routing).

A number of stores are listed in the tertiary window 519, and information such as pricing, payment to advertiser, inventory levels and other data can also be shown along with the store name. The content creator is then permitted to select one or more stores for the link creation by checking boxes 521. In at least one embodiment, when multiple stores are present, the content creator may elect to order the stores by entering numeric rankings in the boxes (which in this case would be text fields instead of check boxes). When a link is subsequently shown to a consumer, the highest ranked store would be used, unless the inventory level of the product is zero or shows as out of stock, in which case a lower ranked store still possessing inventory could be shown.

In some instances, there may be close matches to a shown product, but there may not be specific matches, because retailers selling the product are not participating, because the actual product is not for sale (e.g. custom made, new line not yet out, etc.). In this case, the content creator can input as much information as is known, and one of several tertiary windows may be shown.

If no product even close to the desired product is found, either due to a lack of information or available options, the window 525 may be shown. This window allows the content creator (editor) to input a URL where similar products may be found 527. In this example, since the products are listed as revenue generators, on a per-click and/or purchase basis, it may be desirable to only allow URLs that correspond to participating retailers. In such a case, a check may be made to ensure that the top-level domain name of the URL corresponds to the participating retailer.

In another instance, a tertiary window 529 may show one or more “close” matches to the data input. In such a case, several options are possible. For example, in the window 529, a number of pictures of products 533 may be shown, which may aid in the editor selecting a specific product. In conjunction with the images, check or text boxes may also be provided for selection, and next to each box a list of product information 531 may be shown. An alternative URL entry space 535 may be provided where the editor can input an alternative retailer.

In another example, instead of the visual window 529, a window with text 539 may be shown. In this example, one or more stores having similar products may be shown, and there may be a number of options 539 listed. Each option may also have one or more boxes for product selection. In this example, although not necessary, the process may, on mouse-over of an option, for example, show another window 543. This window may contain product information 545 for the specific option, as well as a picture 547 of the particular product.

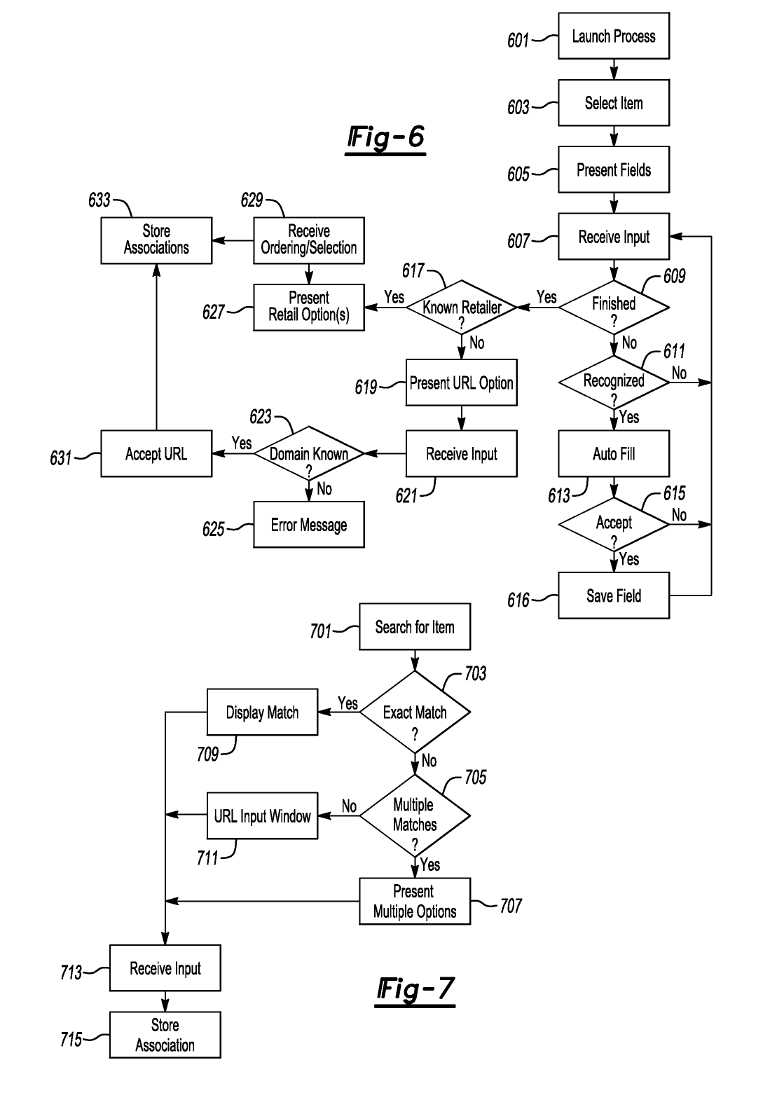

FIG. 6 shows an illustrative example of an illustrative process for advertisement creation. This is an underlying process that minors some of the top-level display options shown with respect to FIG. 5. In this illustrative example, the process begins with launch 601. As previously noted, the process may be running as a plugin, for example, on an editor's creation website. The editor may be in the process of creating content, which may have a variety of pictures associated therewith.

In this example, each of the pictures on the website is provided with a link from the intermediary application (which recognizes embedded images on the pages), and clicking on the link will launch the process for that particular picture. This is just one illustrative example of how the process may be initiated.

A particular item in a particular picture may be selected 603, although selection of a specific picture (not shown) may occur first. Once the item has been selected, the secondary window (e.g., window 503) may be shown with a variety of input fields. Input into a number of these fields can then be received by the process.

In this illustrative example, as input is being typed in a given field, the process may check to see if a “lookup” button has been pressed, or, in another instance, the process may check to see if a known product has resulted from the input of sufficient data. If the process is not finished 609 (i.e., no stop has been indicated and no specific match is yet found), then data entry can continue.

As the data is being entered, the process can check to see if the first portion of a string matches any string in the database of retailers and products 611. For example, if the letters “DK” had been entered in the manufacturer category, the process may recognize these as the start of “DKNY” and auto-fill the remaining letters in 613 (since there was only one likely choice). If the editor accepts the suggestion, the field entry may be saved 616, and in either event input can continue if needed.

Once sufficient input to identify a known product has been input, or the editor has indicated input completion, the process may check to see if there is a known retailer selling the specific or a similar product to that selected 617. If there is no retailer to be found, the process may present an option to input a URL 619 and receive an input URL from the editor 621.

As previously noted, since this process relates to a pay-for-advertising process, this process checks to see if a top-level domain 623 is known. For example, if the editor entered www.macys.com/mens/shirts, the process would check to see if www.macys.com was on an acceptable list of retailers. If the retailer was unacceptable, the process may present an error message 625. Otherwise, the process may accept the URL 631 and store the appropriate associations with the link to provide back-end content to a user.

If the product or a similar product is sold by a known retailer within the system (in this case, although any retailer, participant or not, could be used), the process may present a list of retail options 627. The editor can then input a selection of a retailer or an ordering of multiple retailers 629 and the appropriate associations can then be created and stored 633.

FIG. 7 shows an illustrative example of an item discovery process. This illustrative example shows how various items can be found in an intermediary database as fields in an item lookup screen are filled-in by an editor. In this example, the search is initiated 701.

If an exact match for a product is found 703, the process can display information relating to one or more retailers selling the exact match 709. In the case where an exact match cannot be found, the process may determine if one or more similar items can be found 705, which may not exactly match the item in question. In such a case, multiple options may be presented 707 and the editor can select one or more of these items as similar matches for use in advertising.

If no matches are found that are even similar (by the standards of the database), the process may present the URL window option 711. Selection of any items or entry of a URL 713 can complete the creation process, at which point the appropriate associations can be stored.

The associations can include, but are not limited to, source (i.e. online provider), retailer, price, price-per-click, price-per-purchase, etc. For example, in one instance, the retailer may pay a small price per click to the site, a percentage of the purchase price of the item, and then some other or same percentage of additional goods purchased as a result of the click. Since this information may change over time, the initial information may be saved if, for example, the retailer is willing to “grandfather” in advertisements created on an earlier payment schedule. Other useful information about the product and a copy of the picture itself may also be archived.

FIG. 8 shows an illustrative example of a retailer presentation process. In this example, the process may receive a query 801 and progress through the lookup process 803, such as that shown in FIG. 7. If an exact match is found, there may be no need to progress further, and the retailer(s) with the exact product may be shown. If there are not multiple retailers for a product 805 the match may be shown 807.

If there are multiple retailers available 805, the process may then determine if a particular retailer has paid a premium to be listed first on a list of possible options 809. For example, for a particular shirt, there may be four retailers. Retailer A may pay a small premium to be listed first under a variety of circumstances. For example, a certain retailer may want to be listed first with respect to all shirts. Another retailer may want the same treatment with respect to a particular brand or manufacturer. A third retailer having excess inventory of a particular shirt may want to be listed first for that item specifically. If one or more retailers has paid a premium with respect to some aspect of the particular product in question 809, the process may order the retailers based on, for example, a price paid for higher listing 811.

Since the editor is shown, in at least one example, a list of retailers and products that may contain upwards of ten retailers, it may be advantageous for a retailer to be listed at the top of the list, to increase the likelihood of selection by the editor as a primary or only source for a product advertised.

If any retailers remain (i.e., non-premium) 813, the process may then continue to list the retailers in order of preference as indicated (and saved) by an editor 815. For example, cross-licensing deals with particular publications and retailers may result in a desire for an editor to select a particular retailer over others. Placing preferred retailers higher on the list facilitates the creation process. In this example, if the editor has a preference for any non-premium retailers, they will be ordered by editor preference 817.

If there are still remaining retailers 819, the process may then order the retailers based on the price the retailer pays per click or per purchase (or by other suitable variable) 821.

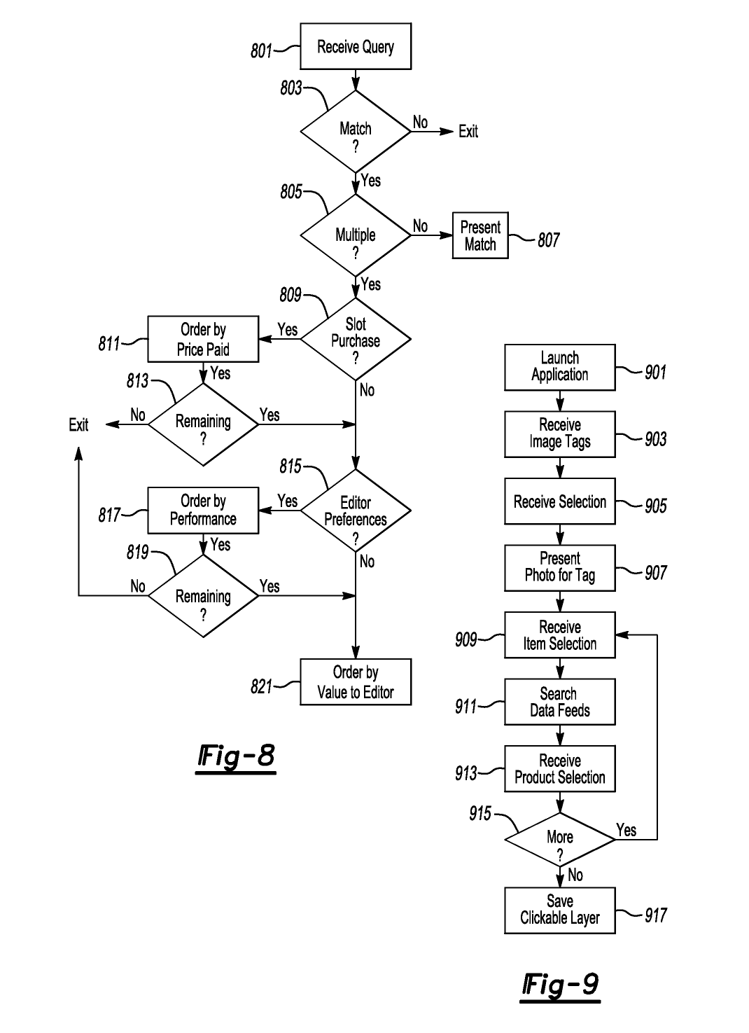

FIG. 9 shows an illustrative example of a photo tagging process. In this illustrative example, an implementation of the illustrative examples is shown. Here, the plugin application is launched by an editor when content has been created 901. The process scans the created content for image tags (e.g. embedded images) and receives a number of tags related to the specific images 903.

A particular image is then selected 905, and the image is presented, in this example, in a new window for product selection 907. A particular item within the picture is then selected 909, and information relating to this product is entered. Database datafeeds are then searched 911 and matches or similar items are presented for selection of a specific retailer product to be associated with the image 913. If additional items in the image are desired to be linked, the process can continue.

Once all the items relating to the process have been selected, a clickable layer can be saved 917. In this example, when a user mouses over the image in question, the clickable layer can be overlaid (in a transparent fashion, for example) and may include product information in a clickable format for one or more of the products shown in the picture.

In one illustrative example, the clickable layer is an invisible, asynchronous element, that once created lives independently of the image on the content producers site. However, after a content producer embeds a single line of JS code into the global footer of their website template, each time that a page is loaded and this JS code is executed, each page is scanned, looking for images that may be enabled with sales opportunities, and if such an image is found, the invisible, asynchronous layer is fetched and overlaid on-top of the JPEG. The connective tissue between the JPEG on the content producers site and the invisible layer created, is the image URL. The two marry together and are viewable and clickable due to the line of JS running.

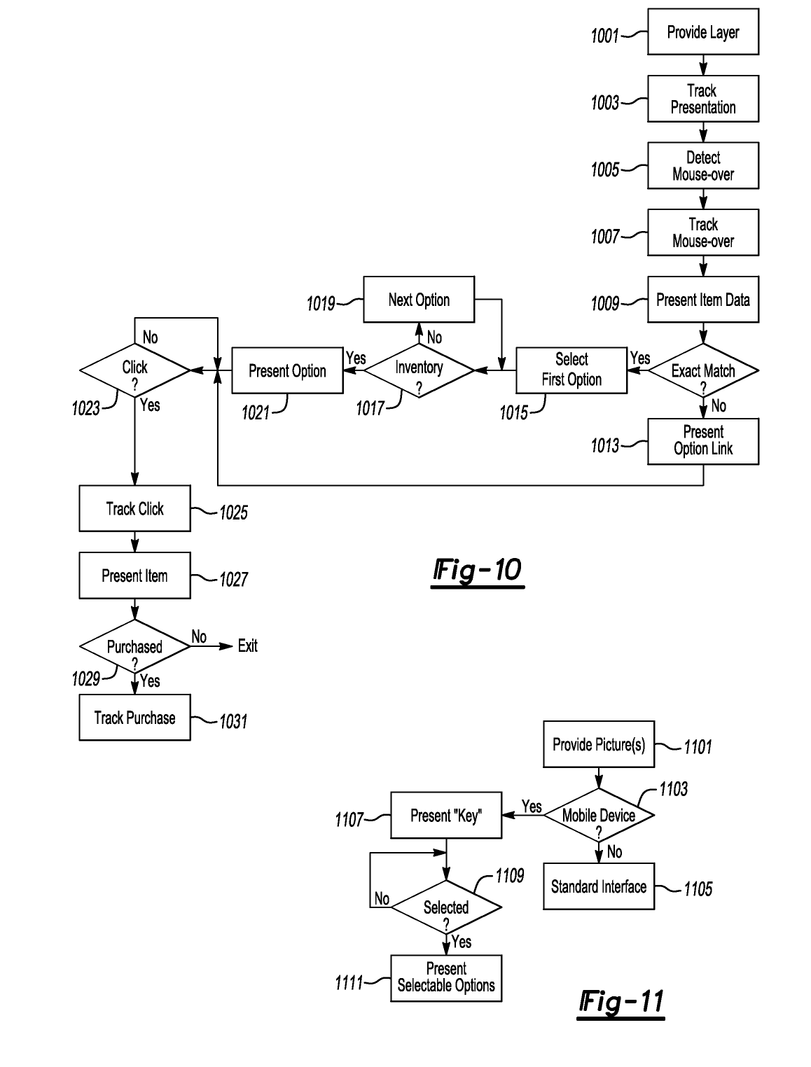

FIG. 10 shows an illustrative example of a presentation tracking process. In this illustrative example, an image is presented to a consumer for utilization (more commonly know as an “impression”), and a number of metrics related to this image are tracked for feedback to retailers and/or editors to gauge the success of one or more images viewed on a site.

In this example, the process provides a clickable layer for each tagged image that has gone through the advertisement creation process 1001 for a front-end user or consumer viewing a digital site with an enabled image. Presentation of each image is tracked 1003, so that an editor, for example, can know how many total times clickable images were shown to potential buyers.

In conjunction with this, any mouse-over of a clickable image is detected 1005 and tracked 1007, so that the editor can know how many times a user moved over an image and was shown more detailed product information relating to that image 1009.

When the item data is shown, the process may either show specific information 1013 for an exact match of the item 1011, or may go through a secondary process if multiple retailers for an exact or similar item are available. A first option is selected 1015 and inventory levels are checked for that item 1017. If the retailer does not have sufficient inventory remaining, a next option may be selected 1019. This process could continue until an item actually available for immediate purchase is found.

Once the appropriate item is shown 1021, the process tracks 1025 whether or not the consumer clicks on the advertisement 1023. Following the click, a window showing the product and providing purchase options is shown 1027. If the user purchases the item (and/or other items) 1029, the process can also track the dollar amount and/or action of the purchase 1031.

In another illustrative example, this secondary process can also be done post-click on a redirect server. As a user clicks on a link for a desired product, the user is first taken to the re-direct server where the information look-up can also happen. From here, the user is resolved onto the properly decided product. The re-direct step may happen instantaneously

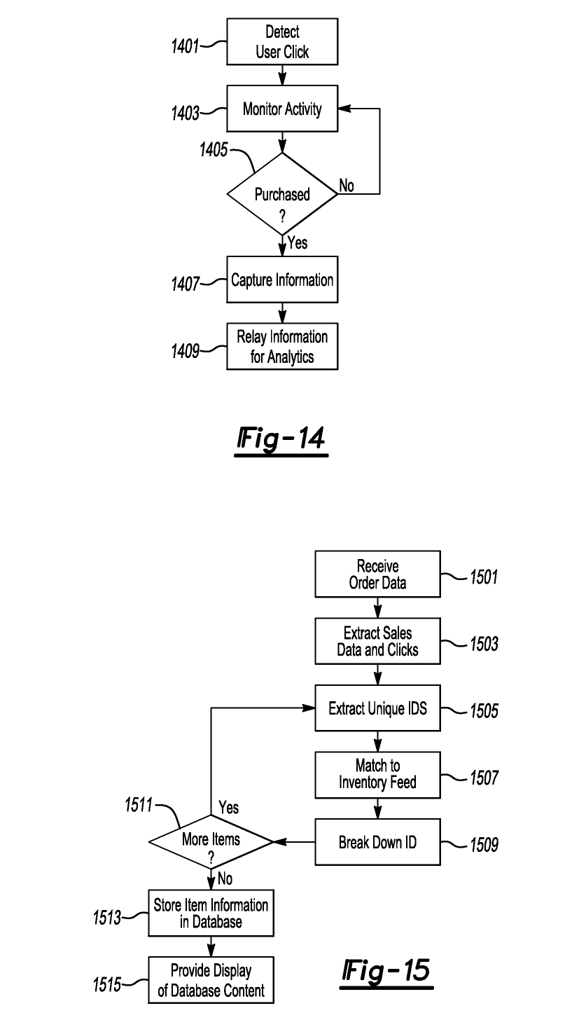

In at least one illustrative example, shown in FIG. 14, a process for purchase tracking is provided.

In this illustrative example, after a user clicks on a desired product 1401 and is taken to product purchase page on a retailer site, user activity is monitored 1403. Monitoring continues until, for example a purchase is made 1405. The tracking mechanism may capture the appropriate sales information 1407, including, but not limited to: Order Number, Date & Time of Purchase, Individual items purchased, including their unique identifier(s) {UPC, SKU or other}, Purchase Price of each item, and Sale Total. This information may then be sent to the intermediary (providing the illustrative embodiments to retailers and content providers) for analytics 1409.

Once this information is received 1501, a parsing algorithm may dissect each order and populates a dashboard that each respective content producer can see. FIG. 15 shows an illustrative example of a parsing and analytics function. Basic information like total sales driven to each respective retailer and total clicks 1503 are possible informative data points.

However, during the data parsing function, we extract the unique identifier from each sales report 1505 (say levi's 501 jean had a unique identifier to a retailer=KUX8785) and match it up against the inventory feed that we receive from the retailer 1507. From here, KUX8785 may be broken down 1509 into more meaningful information=Retailer=Macys, Brand=Levis, Category=Jeans, Product Type or Model=501, Color=Blue, Purchase Price=$49.99, etc. There may be multiple items per purchase where the same logic occurs 1511. After the unique identifiers are parsed into more digestible & valuable information (Brand and Category), each item purchased is stored into a queryable database by respective Brand, Category, Retailer or other unique attributes 1513. From here, a content producer could access this information in an easy and meaningful way 1515.

For example, a magazine could create one hundred sales opportunities by annotating multiple images on their website using the illustrative content providing embodiments. As users roll-over and click on the content producer end, all information is recorded and stored. Furthermore, once a user clicks through to a retailer and purchases items, the sales information is sent back to the intermediary software provider. The data may the be run through the data science parsing algorithm and populated into an interactive dashboard.

For example, in an illustrative example, a content producer may add a date range and be able to see the following exemplary, non-limiting items: active HyperPhotos, number of HyperPhoto® impressions, number of roll-overs on HyperPhotos, number of clicks on a HyperPhoto® (or product link in a HyperPhoto®), percentage of click-throughs, number of complete sales, total gross retail sales driven, percentage of fees payable to content producer and conversion rate (clicks/sales). Also, there is a chart displaying HP impressions on a daily, or instant basis. HyperPhoto® is a registered name relating to the interactable photos, but generally this description refers to any clickable photos created using the illustrative embodiments.

In one example, a “Brand Tab” may be provided. This tab is populated by parsing out each sale, from each retailer, and each item purchased. The unique identifier associated with each product purchased is matched up with the Inventory Feed from said retailer and broken down into: Brand, Category, Purchase Proce, Color, Etc. From here, a content producer can dial in a date range, choose a particular Brand or Manufacturer that they want to find more information about, in relation to the sales that have occurred through their site through HyperPhotos, and see the following exemplary information: Total Dollar Amount generated by readers for the Brand or manufacturer, based on time constraints, Number of Units Sold, Category breakdown of most desirable items sold by Brand (ie, 500 items were categorized as accessories, 245 were shoes, 103 were jeans, etc) and doman's responsible for the sales: Marc Jacobs is sold at multiple retail outlets. In this example, the content producer can see that Neiman Marcus sold the most Marc Jacobs products for the month of February 2012, followed by Bloomingdales, etc.

In another example, a “Retailer Tab” is provided. This tab may show the following: Average shopping basket sale, Average Dollar value per click, Sales over time, Revenue generate per retailer, and clicks per retailer.

FIG. 11 shows an illustrative example of a mobile presentation process. In this illustrative example, a content providing application (e.g., webzine or other provider) is running on a mobile device such as a tablet or phone. Since these devices typically lack mice, the concept of a mouse-over may not be sufficient to initiate product presentation. In such a case, each image for which the application may possess a clickable layer may have an icon or other indicia provided thereto.

A number of such pictures may be provided 1101 and if a mobile device is detected 1103, the process may present the icons or keys with respect to each picture 1107. Touch selection of a clickable picture 1109 may then result in presentation of a number of selectable options 1111 with respect to the products in that picture. If the platform is non-mobile, standard display functionality may result 1105

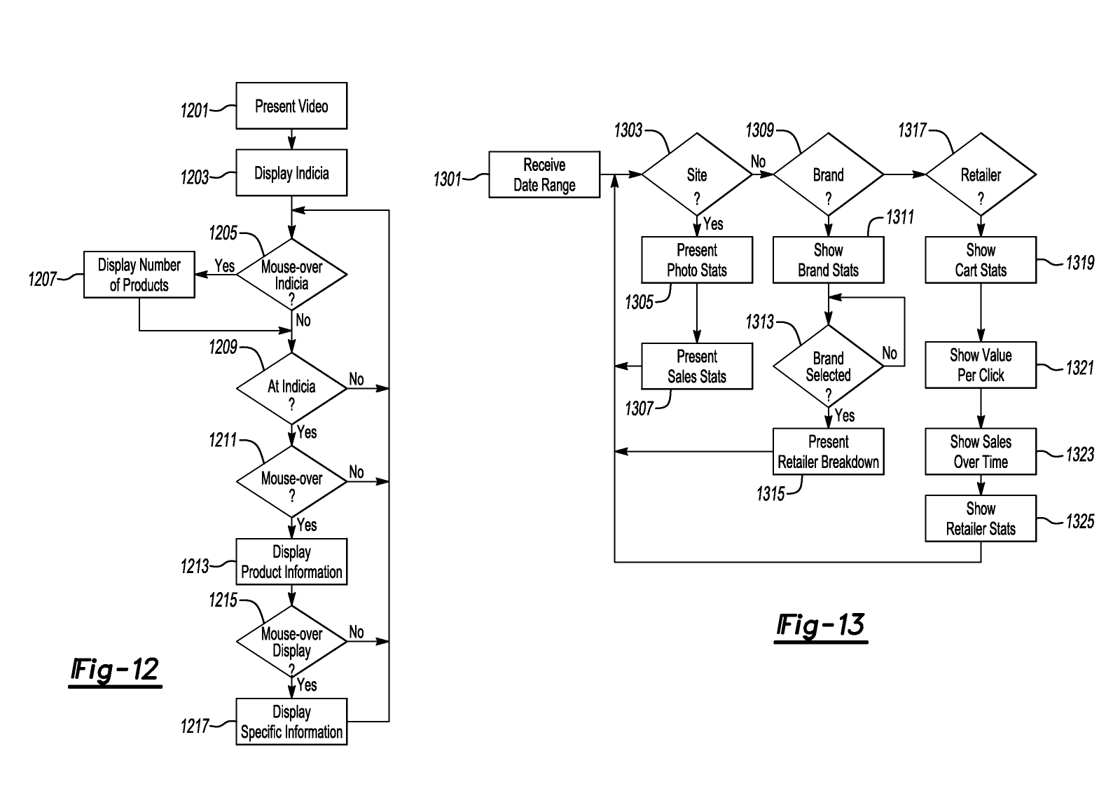

FIG. 12 shows an illustrative example of a video presentation process. In this illustrative example, a video having advertisements embedded therein is presented 1201. Along the bottom of the video, in the timeline, a number of indicia may be shown that indicate points in the video where product advertisements are available if desired 1203.

In this case, the indicia are small dots that are large enough to accept mouse-overs. If the user mouses over one of the indicia 1205, the process may display the number of products available at that point 1207. Additional information relating to the products may also be shown, as desired (e.g., without limitation, item categories, descriptions, prices, even links).

The process then waits until the video has reached playback at an indicia point 1209. If the video is playing within a tolerance of an indicia point, the process may detect a mouse-over of the video 1211 (or the ad could simply be displayed). If the mouse-over is detected, in this case, the process then displays some information related to one or more products shown in the video 1213. In this example, so as not to intrude overmuch on the video, a limited set of information may be displayed at first, and a mouse-over of the information 1215 may result in the display of additional product information 1217. The display can also be clicked to launch a product website.

In one example, as each indicia point is reached, very limited information may be shown on mouse-over or automatically. For example, a small window may say “coat” “scarf” “hat”. Mousing over each word would then bring up additional product information, and clicking would launch a retailer site.

FIG. 13 shows an illustrative example of a statistic presentation process. In this illustrative example, the process provides an editor or retailer with information relating to the success and scope of advertisement presentation through the illustrative embodiments.

Here, an editor, for example, can input a date range 1301 or even a time range if desired. The editor also has the option of selecting information relating to a site, a brand or a retailer in this example. Site information relates to the editor's site, brand information relates to the success of advertising on a per-brand basis, and retailer information relates to the amount of revenue flowing back from a particular retailer.

If the site option is selected 1303, the process may present a variety of site stats 1305, many of which are discussed with respect to the tracking in FIG. 10. These stats relate to, for example, without limitation, sales stats 1307, presentation stats, click stats, view stats, mouse-over stats, etc. The various data can be visually presented and broken down in custom formats for a given editor if desired. This level of metrics will aid the editor in future decisions about the implementation and usage of the intermediary advertising application.

If the brand option is selected 1309, the process can show stats relating to brand successfulness 1311. For example, this can help an editor determine which brands the readers are likely to respond to, based on past history. Top selling brands can be shown, and individual brands can be selected 1313 for an in-depth analysis of the given brand. For a particular brand, product information, sales information and retailer information, among other things, can be provided 1315.

If the retailer option is selected 1317, the process can show stats relating to a particular retailer. These can include, but are not limited to, cart statistics 1319 (average cart, largest order, smallest order, etc.), a value-per-click stat 1321 (i.e., how much average revenue each click of the advertisement eventually generates), sales over time stats 1323, and other general stats for that retailer 1325 and/or for a variety of retailers (e.g., top retailers, best revenue generators, etc.).

All of the illustrative embodiments presented herein, when used in conjunction, can form a powerful advertising content providing intermediary. Retailers can register to have their products sold, and provide financial incentives for doing so. Editors can tag a number of photographs provided as part of everyday journalism in their publications, and thereby increase advertising revenue. Tracking and metrics allow both ends of the spectrum to improve the overall efficiency and effectiveness of the experience, and the consumer can be provided with an ability to purchase additional products in a seamless manner, while perusing their favorite publications.

While various exemplary, illustrative, non-limiting embodiments have been described in detail, those familiar with the art to which this invention relates will recognize various alternative designs and embodiments for practicing the invention, which is only limited by the following claims.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising: a processor configured to: receive input of a digital photograph to which an advertisement will be applied; receive selection of an item within the photograph; present a plurality of input fields relating to characteristics of the item; receive input in one or more of the fields; receive at least one database record corresponding to received input; present the at least one database record to a content creator for selection; receive selection of at least one database record; and store the selected at least one database record with respect to the photograph, including at least identification of a content provider where the photograph will be displayed.

2. The system of claim 1, wherein an input field includes a manufacturer.

3. The system of claim 1, wherein an input field includes an item description.

4. The system of claim 1, wherein an input field includes a gender.

5. The system of claim 1, wherein an input field includes a SKU or UPC.

6. The system of claim 1, wherein an input field includes a source.

7. The system of claim 1, wherein the database record is an exact match based on received input.

8. The system of claim 1, wherein the database record has characteristics within a tolerance range of received input.

9. The system of claim 1, wherein the presented database record includes at least a product retailer.

10. The system of claim 1, wherein the presented database record includes at least a product price.

11. The system of claim 1, wherein the presented database record includes at least a product image.

12. The system of claim 1, wherein the processor is further configured to receive an ordered selection of a plurality of database records.

13. A computer implemented method comprising: receiving input of a photograph to which an advertisement will be applied; receiving selection of an item within the photograph; presenting, from a data processing computer, a plurality of input fields relating to characteristics of the item; receiving input in one or more of the fields; receiving at least one database record corresponding to received input; presenting the at least one database record to a content creator for selection; receiving selection of at least one database record; and storing the selected at least one database record with respect to the photograph, including at least identification of a content provider where the photograph will be displayed.

14. The method of claim 13, wherein an input field includes a manufacturer.

15. The method of claim 13, wherein an input field includes an item description.

16. The method of claim 13, wherein an input field includes a gender.

17. The method of claim 13, wherein an input field includes a SKU or UPC.

18. The method of claim 13, wherein an input field includes a source.

19. The method of claim 13, wherein the database record is an exact match based on received input.

20. The method of claim 13, wherein the database record has characteristics within a tolerance range of received input.

21. The method of claim 13, wherein the presented database record includes at least a product retailer.

22. The method of claim 13, wherein the presented database record includes at least a product price.

23. The method of claim 13, wherein the presented database record includes at least a product image.

24. The method of claim 13, wherein the processor is further configured to receive an ordered selection of a plurality of database records.

25. A computer readable storage medium storing instructions that, when executed by a processor, cause the processor to perform a method comprising: receiving input of a photograph to which an advertisement will be applied; receiving selection of an item within the photograph; presenting, from a data processing computer, a plurality of input fields relating to characteristics of the item; receiving input in one or more of the fields; receiving at least one database record corresponding to received input; presenting the at least one database record to a content creator for selection; receiving selection of at least one database record; and storing the selected at least one database record with respect to the photograph, including at least identification of a content provider where the photograph will be displayed.
